(19) United States
(12) Patent Application Publication
(10) Pub. No.: US 2020/0212551 A1
(43) Pub. Date: Jul. 2, 2020

(54) ANTENNA AND ON-BOARD DEVICE

(71) Applicant: AAC Technologies Pte. Ltd., Singapore City (SG)

(72) Inventor: Yachuan Shen, Shenzhen (CN)

(21) Appl. No.: 16/703,902

(22) Filed: Dec. 5, 2019

(30) Foreign Application Priority Data
Dec. 27, 2018 (CN) 201811619058.9

(51) Int. Cl. H01Q 1/38; H01Q 1/52; H01Q 21/06; H01Q 21/00

(52) U.S. Cl. CPC H01Q 1/38; H01Q 21/0006; H01Q 21/065; H01Q 1/523

(57) ABSTRACT

Embodiments of the present invention relate to the field of communication technology, and disclose an antenna and an on-board device. In the present disclosure, an antenna comprises a dielectric plate, an antenna array module and an impedance transformer that are both arranged on a first side of the dielectric plate, a feed point arranged on an edge of the dielectric plate, and a reflecting plate attached to a second side of the dielectric plate, wherein an input terminal of the impedance transformer is connected with the feed point, and an output terminal of the impedance transformer is connected with the antenna array module. In an embodiment of the present disclosure the antenna can support an on-board millimeter wave communication in a 5G communication environment.

### TECHNICAL FIELD

Embodiments of the present disclosure relate to the field of communication technology, in particular to an antenna and an on-board device.

### BACKGROUND

With the development of communication technology, an antenna plays a more and more important role in data communication. In the existing technology, different antenna structures are respectively adopted for 3G and 4G communication technologies to meet different types of data communication requirements.

The inventors found that there are at least the following problems in the existing technology: at present, 5G communication has become an inevitable trend in the development of communication technology; in order to comply with this development trend, a 5G millimeter wave frequency band is necessary for an on-board communication, however there are few antennas for the 5G millimeter wave communication in the existing technology.

### BRIEF DESCRIPTION OF THE DRAWINGS

One or more embodiments are described as examples with reference to the corresponding figures in the accompanying drawings, and the examples do not constitute a limitation to the embodiments. Elements with the same reference numerals in the accompanying drawings represent similar elements. The figures in the accompanying drawings do not constitute a proportion limitation unless otherwise stated.

FIG. 1 is a schematic diagram of a front side of an antenna in a first embodiment of the present disclosure;

FIG. 2 is a schematic diagram of a side face of a dielectric plate in a first embodiment of the present disclosure;

FIG. 3 is a schematic diagram of a side face of an antenna in a first embodiment of the present disclosure;

FIG. 4 is a schematic diagram of a back side an antenna in a first embodiment of the present disclosure;

FIG. 5 is a beam pointing schematic diagram of an antenna in a second embodiment of the present disclosure;

FIG. 6 is a reflection coefficient graph of an antenna in a second embodiment of the present disclosure;

FIG. 7 is a transmission efficiency diagram of an antenna in a second embodiment of the present disclosure.

### DETAILED DESCRIPTION

The embodiments of the present disclosure will be described in detail below with reference to the accompanying drawings in order to make the objectives, technical solutions and advantages of the present disclosure clearer. However, it will be apparent to those skilled in the art that, in the various embodiments of the present disclosure, numerous technical details are set forth in order to provide the reader with a better understanding of the present disclosure. However, the technical solutions claimed in the present disclosure may be implemented without these technical details and various changes and modifications based on the following embodiments herein.

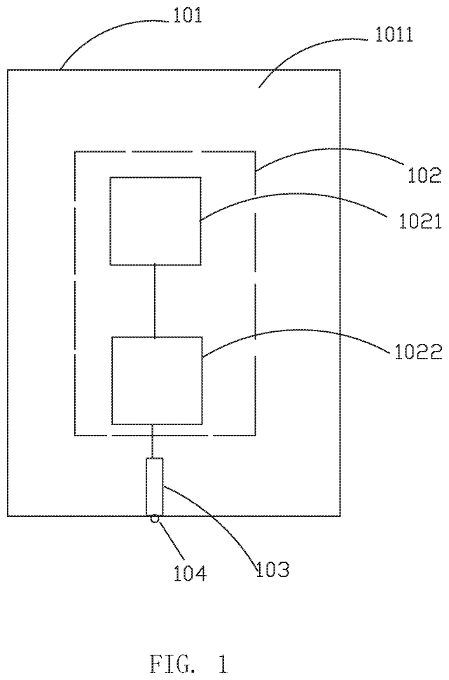

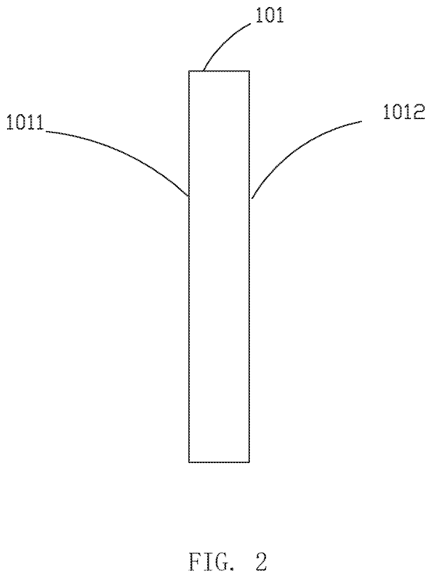

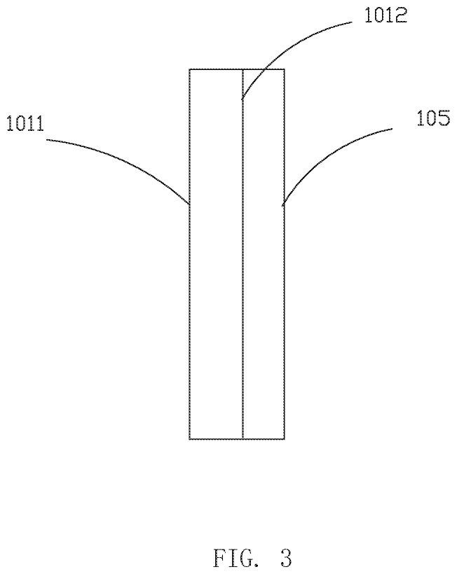

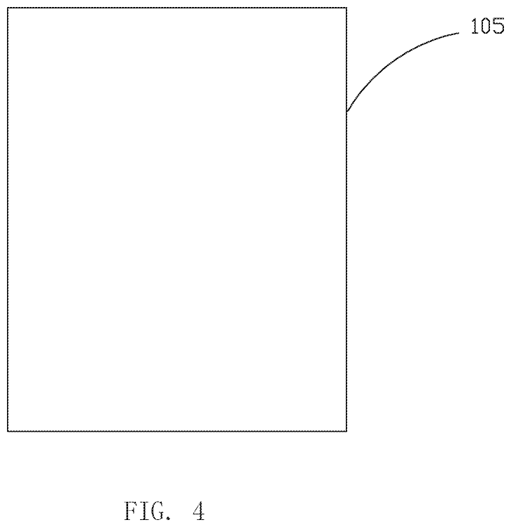

A first embodiment of the present disclosure relates to an antenna. FIG. 1 shows schematic diagram of a front side of the antenna. The antenna includes a dielectric plate 101, an antenna array module 102 and an impedance transformer 103 that are arranged on a first side 1011 of the dielectric plate, and a feed point 104 arranged on an edge of the dielectric plate 101. FIG. 2 shows schematic diagram of a side face of the dielectric plate. The dielectric plate 101 includes the first side 1011 and a second side 1012. FIG. 3 is schematic diagram of a side face of the antenna in an embodiment of the present disclosure, and FIG. 4 shows a back side of the antenna. According to FIG. 3 and FIG. 4, the back side of the antenna is covered by a reflecting plate 105. Accordingly, the antenna in the embodiment of the present disclosure further includes the reflecting plate 105 attached to the second side 1012 of the dielectric plate. An input terminal of the impedance transformer 103 is connected to the feed point, and an output terminal of the impedance transformer 103 is connected to the antenna array module 102.

It should be noted that in this embodiment, the first side specifically refers to the front side of the dielectric plate 101, while the second side specifically refers to the back side of the dielectric plate 101. In this embodiment, due to a barrier effect of the reflecting plate 105, most of the signals from the antenna array module 102 may be radiated from the front side of the antenna, thereby achieving the purpose of radiating signals from the antenna in a specified direction and improving transmission efficiency of the antenna.

Specifically, in this embodiment, the impedance transformer 103 and the antenna array module 102 are connected by a first transmission line, so that the impedance transformer 103 may effectively transmit the signals to the antenna array module 102.

Here, as shown in FIG. 1, the antenna array module 102 in this embodiment includes a first antenna array 1021 and a second antenna array 1022 which are connected in series. It should be noted that in this embodiment, the first antenna array 1021 and the second antenna array 1022 are connected by a second transmission line, so that the signals from the impedance transformer 103 may be effectively transmitted between the two antenna arrays.

Here, in this embodiment, edges of the dielectric plate 101 include a first short edge, a first long edge, a second short edge and a second long edge which are sequentially connected. The feed point 104 is arranged on the first short edge.

Here, the dielectric plate 101 in this embodiment adopts a low-loss millimeter wave dielectric material. For example, it may be a high-frequency plate RO4835T of Rogers. Of course, in this embodiment, the RO4835T material is only taken as an example. The dielectric plate with other materials, which may mainly achieve the barrier effect on the radiation signals, is also within the protection scope of the present disclosure. The specific material of the dielectric plate is not limited in the embodiment of the present disclosure.

Compared with the existing technology, the antenna in this embodiment includes the antenna array module and the impedance transformer that are both arranged on the first side of the dielectric plate, and the reflecting plate attached to the second side of the dielectric plate. The millimeter wave signal may be acquired and radiated through a connection relation between the antenna components, and the millimeter wave signal may be radiated from the first side of the dielectric plate due to the barrier effect of the reflecting plate, thereby improving the signal radiation efficiency.

A second embodiment of the present disclosure relates to an antenna, and the second embodiment is substantially the same as the first embodiment. This embodiment mainly describes a transmission effect of the antenna.

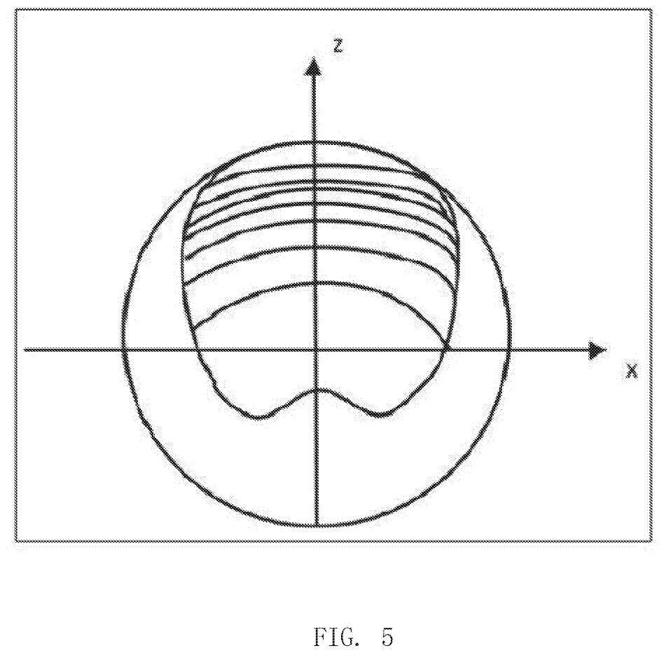

Here, FIG. 5 is a beam pointing schematic diagram of the antenna. The xz plane is perpendicular to the antenna, and a positive direction of the z-axis is directed to the front side of the dielectric plate 101. The denser the curves are in the diagram, the stronger the signal strength is. Therefore, it may be seen from FIG. 5 that the signal strength on the front side of the dielectric plate 101 is strong, while the signal strength on the back side of the dielectric board 101 is weak due to the presence of the reflecting plate 103. Therefore, it may be seen from the beam pointing of the antenna that the reflecting plate 105 has a good barrier effect on the antenna signal.

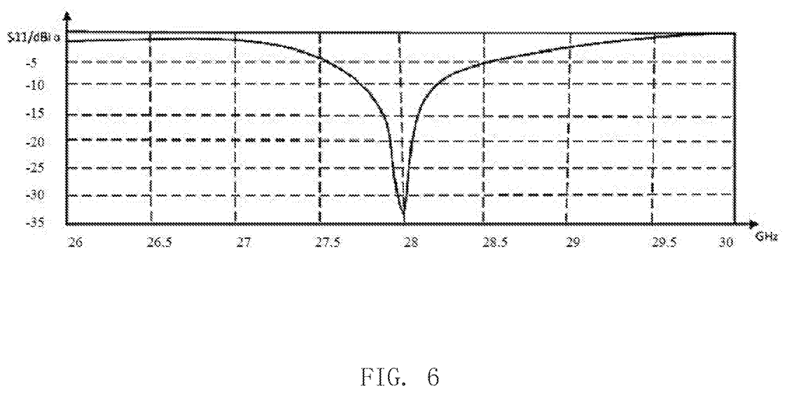

Specifically, FIG. 6 is a reflection coefficient graph of the antenna in the present disclosure. An ordinate value S11 in the graph represents a reflection coefficient value of the antenna. It may be seen from the graph that the antenna supports an effective transmission of the 28 GHz frequency signal at 28 GHz.

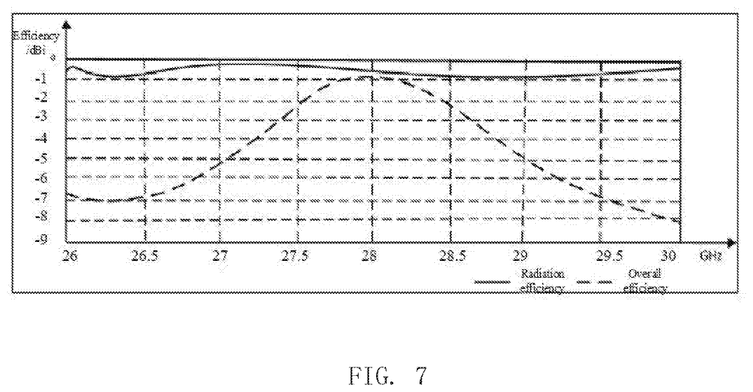

Specifically, FIG. 7 is a transmission efficiency diagram of the present disclosure. As shown in the diagram, a solid curve represents the radiation efficiency, and a dashed curve represents the total efficiency. The antenna in this embodiment may realize an efficient signal transmission at 28 GHz, thereby supporting an effective transmission process of the 28 GHz frequency signal.

Compared with the existing technology, the antenna in this embodiment includes the antenna array module and the impedance transformer that are arranged on the first side of the dielectric plate, and the reflecting plate attached to the second side of the dielectric plate. The millimeter wave signal may be acquired and radiated through a connection relation between the antenna components, and the millimeter wave signal may be radiated from the first side of the dielectric plate due to the barrier effect of the reflecting plate, thereby improving the signal radiation efficiency.

A third embodiment of the present disclosure relates to an on-board device, and this mobile terminal includes the antenna provided in the above-described first or second embodiment.

Here, the on-board device should further include hardware such as a processor, a memory, etc., wherein the memory and the processor are connected by a bus. The bus may include any number of interconnected buses and bridges, and the bus links various circuits, e.g. one or more processors and memories together. The bus may also link together various other circuits such as a peripheral device, a voltage regulator, a power management circuit, etc. These are well known in the art, and therefore will not be further described herein. A bus interface is provided between the bus and an antenna system. A data processed by the processor is transmitted on a wireless medium through the antenna system. Further, the antenna system also receives the data and then transmits the data to the processor. The processor is responsible for managing the bus and normal processing, as well as providing various functions which include timing, a peripheral interface, a voltage regulation, a power management and other control functions. The memory may be configured to store the data used by the processor during performing operations.

Those skilled in the art should appreciate that the aforementioned embodiments are specific embodiments for implementing the present disclosure. In practice, however, various changes may be made in the forms and details of the specific embodiments without departing from the spirit and scope of the present disclosure.

What is claimed is:

1. An antenna, comprising:
a dielectric plate;
an antenna array module and an impedance transformer that are arranged on a first side of the dielectric plate;
a feed point arranged on an edge of the dielectric plate; and
a reflecting plate attached to a second side of the dielectric plate;
wherein an input terminal of the impedance transformer is connected with the feed point, and an output terminal of the impedance transformer is connected with the antenna array module.

2. The antenna as claimed in claim 1, wherein the impedance transformer and the antenna array module are connected through a first transmission line.

3. The antenna as claimed in claim 1, wherein the antenna array module comprises a first antenna array and a second antenna array that are connected in series.

4. The antenna as claimed in claim 3, wherein the first antenna array and the second antenna array are connected through a second transmission line.

5. The antenna as claimed in claim 1, wherein edges of the dielectric plate comprises a first short edge, a first long edge, a second short edge and a second long edge that are sequentially connected; the feed point is arranged on the first short edge.

6. The antenna as claimed in claim 1, wherein the impedance transformer comprises: a quarter wavelength impedance transformer.

7. The antenna as claimed in claim 1, wherein the first side is a front side of the dielectric plate, and the second side is a back side of the dielectric plate.

8. The antenna as claimed in claim 1. wherein a millimeter wave signal radiated from the antenna is a 28 GHz frequency signal.

9. The antenna as claimed in claim 8, wherein the dielectric plate is made of a millimeter wave dielectric material.

10. An on-board device, comprising an antenna, the antenna comprising:
a dielectric plate;
an antenna array module and an impedance transformer that are arranged on a first side of the dielectric plate;
a feed point arranged on an edge of the dielectric plate; and
a reflecting plate attached to a second side of the dielectric plate;
wherein an input terminal of the impedance transformer is connected with the feed point, and an output terminal of the impedance transformer is connected with the antenna array module.

11. The on-board device as claimed in claim 10, wherein the impedance transformer and the antenna array module are connected through a first transmission line.

12. The on-board device as claimed in claim 10. wherein the antenna array module comprises a first antenna array and a second antenna array that are connected in series.

13. The on-board device as claimed in claim 12, wherein the first antenna array and the second antenna array are connected through a second transmission line.

14. The on-board device as claimed in claim 10, wherein edges of the dielectric plate comprises a first short edge, a first long edge, a second short edge and a second long edge that are sequentially connected; the feed point is arranged on the first short edge.

15. The on-board device as claimed in claim 10, wherein the impedance transformer comprises: a quarter wavelength impedance transformer.

16. The on-board device as claimed in claim 10, wherein the first side is a front side of the dielectric plate, and the second side is a back side of the dielectric plate.

17. The on-board device as claimed in claim 10, wherein a millimeter wave signal radiated from the antenna is a 28 GHz frequency signal.

18. The on-board device as claimed in claim 10, wherein the dielectric plate is made of a millimeter wave dielectric material.
